(19) United States
(12) Patent Application Publication
(10) Pub. No.: US 2012/0210517 A1
(43) Pub. Date: Aug. 23, 2012

(54) PERFECT GYM TOWEL

(76) Inventor: Nimeshkumar Patel, Mission, TX (US)

(21) Appl. No.: 13/113,872

(22) Filed: May 23, 2011

Related U.S. Application Data
(63) Continuation-in-part of application No. 13/084,780, filed on Apr. 12, 2011, now abandoned.
(60) Provisional application No. 61/444,508, filed on Feb. 18, 2011.

(51) Int. Cl. D06L 1/00; F26B 7/00; B32B 3/06

(52) U.S. Cl. 8/137; 428/221; 428/100; 34/427

(57) ABSTRACT

Perfect Gym Towel is a multi-purpose towel to be used during exercise activities. More specifically, the Perfect Gym Towel comprises one side having a fabric sheet for absorbing sweat of a user and a second side comprising an anti-bacterial barrier to be placed on gym equipment during exercise activities or when resting the gym towel during periods of non-use. The antibacterial barrier comprises a rubber-based material, such as an artificial elastomer comprising a polymer, providing a resistant surface. These layers in combination create a usable towel with a water resistant barrier to protect the user from contaminates like germs, sweat, and solvents that are left behind on gym equipment (by other users) which can be absorbed into a traditional gym towel. Perfect Gym Towel is a towel option that can be appreciated by virtually all gym-goers for its cleanliness and protection that the product affords.

### CROSS-REFERENCE TO RELATED APPLICATION

The present application is a Continuation-in-Part (CIP) related to and claims priority from prior provisional application Ser. No. 61/444,508, filed Feb. 18, 2011 and to pending non-provisional application Ser. No. 13/084,780 filed Apr. 12, 2011 which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of towels and more specifically relates to an improved sanitary towel for use at a public facility while exercising.

2. Description of the Related Art

Towels provide a valuable function in society. First and foremost, towels are used to dry one's skin after emerging from water. Many people enjoy the feeling of a soft, cool and fresh scented towel waiting after a hot shower. Beach goers and pool swimmers find comfort and warmth in a waiting towel after getting out of the water. Hand towels are ‘handy’ for drying recently washed hands, drying dishes, and cleaning small messes. Lastly, sports players, gym enthusiasts, outdoor workers, and professional athletes rely on towels to absorb dripping sweat. Regardless of the purpose, towels perform a daily and continuous utility in society.

Many individuals use a small towel at the gym in order to wipe sweat from their face during a workout. In between use, the towel is often placed on a piece of gym equipment, such as a bench or set of handlebars. Since the towel is absorbent, it typically soaks up whatever is residing on the equipment, such as sweat, cleaning solvent, germs, and more. The individual then picks up the towel and wipes their face. This results in a transfer of the contaminants from the towel to the user's face. Despite the evolvements in the manufacturing of innovative towels, a more direct and specific solution is needed.

Various attempts have been made to solve the above-mentioned problems such as those found in U.S. Pat. and Pub. Nos. U.S. Pat. No. 4,278,719 to Samecki; U.S. Pat. No. 5,735,004 to Wooten et al; U.S. Pat. No. 6,186,155 to Cheek; U.S. Pat. No. 5,817,379 to Rich et al; U.S. Pat. No. 5,386,603 to Drust; U.S. Pat. No. D561,290 to Prior et al; and 2002/0068144 to McCumber. This prior art is representative of towels with various surfaces on each side. None of the above inventions and patents, taken either singly or in combination, is seen to describe the invention as claimed.

Ideally, a sanitary gym towel should be easy to use, operate reliably to avoid unhealthy transfer of germs and be manufactured at a modest expense. Thus, a need exists for a Perfect Gym Towel to provide a towel option that may be used by virtually all gym goers to protect against unknown elements and to avoid the above-mentioned problems.

### BRIEF SUMMARY OF THE INVENTION

In view of the foregoing disadvantages inherent in the known sanitary towel art, the present invention provides a novel Perfect Gym Towel. The general purpose of the present invention, which will be described subsequently in greater detail, is to provide a towel to be used during exercise or athletic activities whereby one side of the towel comprises a sweat absorbent wicking volume for absorbing the sweat of the user and the other side comprises a water and sweat-proof rubber material for deflecting germs, bacteria, and solvents.

Perfect Gym Towel, as disclosed herein, comprises a towel to be used during or after exercise activities. More specifically, the Perfect Gym Towel comprises one side comprising a fabric sheet for absorbing sweat of the user and a second side comprising an antibacterial bather to be used when resting the gym towel during periods of non-use. A fabric fastener, such as stitches, may be used to affix the fabric sheet to the antibacterial barrier.

The antibacterial barrier preferably comprises a rubber-based material, such as an artificial elastomer comprising a polymer, providing a resistant surface. In such a manner, germs, bacteria, and other contaminates that exist in public facilities, such as a gym, will not be soaked up by the absorbent towel and therefore the towel will be more sanitary for use, thereby promoting good health in its users.

The antibacterial barrier of the present invention preferably comprises a plurality of small dimples thereby forming a dimpled surface. It should be appreciated that the dimpled surface of the antibacterial barrier may reduce the overall surface area of contact. In such a manner, germs and bacteria are less likely to transfer to antibacterial barrier. Further, the dimpled surface may provide greater traction when a gym-user places the Perfect Gym Towel on a surface to be retained while in a resting condition.

The Perfect Gym Towel may be produced in different sizes and colors appealing to a wide variety of gym users. Further, the fabric sheet or the antibacterial barrier of the Perfect Gym Towel may comprise indicia in the form of writing, symbols, or a logo, thereby providing a more aesthetically pleasing appearance of the gym towel. A method of use is also described herein.

Perfect Gym Towels may be comprised of two or more layers of various fabric sheets or anti-bacterial, artificial elastomer(s) comprising a polymer, providing a water resistant surface in certain embodiments.

The basic Perfect Gym Towel preferably comprises two layers that may be stitched together, one being an absorbent fabric sheet and that other an anti-bacterial, artificial elastomer comprising a polymer, providing a water resistant surface.

A Deluxe Perfect Gym Towel version may be created by using three layers (multilayered—other embodiments may comprise more than three layers), where the anti-bacterial, artificial elastomer comprises a polymer, providing a water resistant surface that will be stitched between the two sheets of different color fabric sheets. A bright vibrant color fabric sheet for the user's side and a darker colored side that will be placed on gym equipment.

An Ultimate Perfect Gym Towel may be created using four layers. This towel will preferably have two sheet of anti-bacterial, artificial elastomer comprising a polymer that will be stitched between two sheets of different color fabric sheets. A bright vibrant color fabric sheet for the users side and a darker side the will be placed on gym equipment. The at least one bright color provides that the towel is both readily user-identifiable and such that the water/sweat-proof surface is distinguishable from the wicking volume for placing on the equipment using the proper surface touching the equipment. The sweat absorbing loops comprise a first bright color identifying that it is a side of said fabric-based sheet and the water/sweat-proof surface comprises a second bright (or dark) color identifying that it is a side of the rubber-based material (the side to be placed in contact with the equipment.)

The present invention holds significant improvements and serves as a Perfect Gym Towel. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Perfect Gym Towel, constructed and operative according to the teachings of the present invention.

FIG. 1 shows a perspective view illustrating a perfect gym towel in an in-use condition to absorb the sweat of a user while exercising at a gym according to an embodiment of the present invention

FIG. 2 is a perspective view illustrating the perfect gym towel in a resting condition providing an anti-bacterial barrier between an exercise machine surface and the absorbent side of the towel according to an embodiment of the present invention of FIG. 1.

FIG. 3 is a perspective view illustrating an absorbent side of the perfect gym towel comprising a fabric sheet according to an embodiment of the present invention of FIG. 1.

FIG. 4 is a perspective view illustrating an antibacterial barrier comprising a sweat-resistant dimpled surface according to an embodiment of the present invention of FIG. 1.

FIG. 5 is a flowchart illustrating a method of use for the perfect gym towel according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a sanitary gym towel and more particularly to a sanitary gym towel to be used while exercising in a public facility such as a gym.

Gym towels provide a valuable and necessary tool to a gym-user. The gym towel is used to wipe beads of sweat from the face, arms, legs, and the neck. Further, the gym-user often uses the same towel to wipe down the surface of an exercise machine. Gym-users frequently place the towel on the floor or on the exercise machine itself while using the machine or engaging in other types of exercise activities. When the towel is in a resting condition, the absorbent nature of the fabric sheet may soak up germs and bacteria left behind by other gym-users. Consequently, the towel frequently becomes germ-ridden which may lead to the transfer of disease and sickness. Therefore, the primary object of the present invention is to provide an improved sanitary towel to be used by gym-goers, athletes, and other individuals who may wish to reduce the risk of the spreading of disease and improve their overall health.

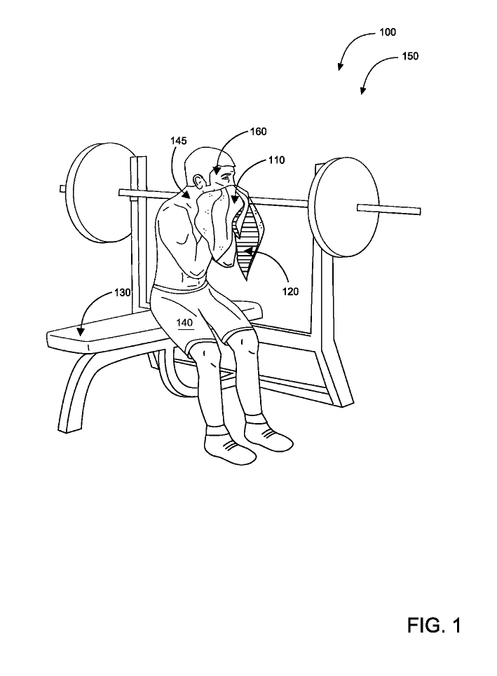

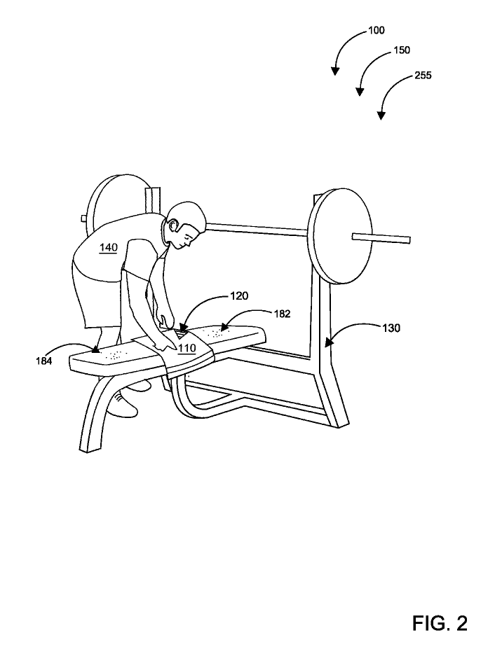

In referring now to FIGS. 1 and 2, illustrating perfect gym towel 100 in an in-use condition 150 according to a preferred embodiment of the present invention. As shown, perfect gym towel 100 may generally comprise fabric sheet 110 which may be used for absorbing sweat 160 of gym-user 140. Perfect gym towel 100 may further comprise antibacterial barrier 120 which may be securely affixed to a back surface of fabric sheet 110. In a preferred embodiment, fabric sheet 110 and antibacterial barrier 120 are cut into a rectangular shape of the same size. Antibacterial barrier 120 may comprise a water resistant material such as a high-grade rubber material for providing a sweat-resistant surface of perfect gym towel 100. As shown in FIG. 1, gym-user 140 may use absorbing surface of fabric sheet 110 for absorbing sweat 160 off skin 135 produced during exercise activity. Fabric sheet 110 integrally comprises a wicking volume for absorbing and retaining sweat 160.

Perfect gym towel 100 may comprise a multi-purpose gym towel for use by gym-user 140 during a workout and may comprise a rectangular, fabric sheet 110 manufactured from terrycloth comprising sweat absorbent loops 305. Sweat absorbing loops 305 may comprise a wicking volume for absorbing sweat 160 which may be stored within fabric sheet 110. Perfect gym towel 100 may further comprise a rectangular, rubber-based material manufactured from artificial elastomer cut to the same size as fabric sheet 110 and may comprise antibacterial barrier 120 for providing a water/sweat-proof surface. In such a manner, antibactieral barrier 120 may prevent contact by gym-user 140 with germs 182 and bacteria 184 present on exercise machine 130. Further, fabric fastener 320 may serve to securely affix fabric sheet 110 to antibactieral barrier 120. When in an in-use condition 150, perfect gym towel 100 may provide a sanitary wipe for gym-user 140 before, during, and after a workout.

Referring now specifically to FIG. 2, illustrating perfect gym towel 100 in resting condition 255 according to a preferred embodiment of the present invention. As shown, once gym-user 140 has dried off sweat 160 from skin 135, perfect gym towel 100 may be laid to rest on antibacterial barrier 120 comprising water resistant surface. In such a manner, germs 182 and bacteria 184 left behind from other gym users will not be absorbed by perfect gym towel 100 as a result of antibacterial barrier 120. Gym-user 140 may confidently place perfect gym towel 100 on either the floor or draped over exercise machine 130 without risk that germs 182 or other bacteria 184 will come into contact with fabric sheet 110 as a result of antibacterial barrier 120.

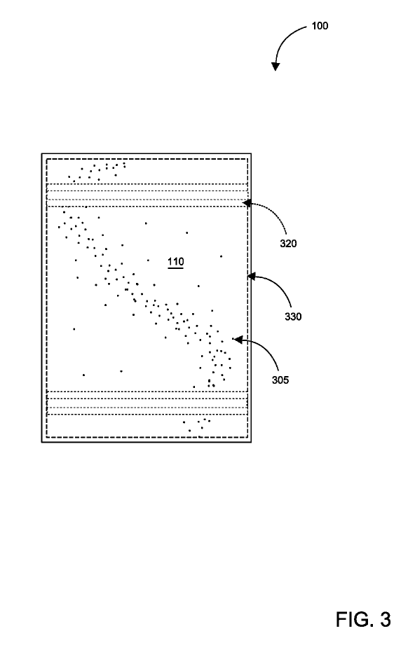

In now referring to FIG. 3, illustrating a sweat-absorbent surface of perfect gym towel 100 according to a preferred embodiment of the present invention. As shown, fabric sheet 110 may comprise a suitable, machine-washable material such as terrycloth comprising a plurality of absorbent loops 305 for absorbing sweat 160 of gym-user 140. It should be appreciated that absorbent loops 305 may serve to increase the wicking volume of fabric sheet 110. In such a manner, gym-user 140 may use perfect gym towel 100 continuously throughout a gym workout or while engaging in exercise activity over a period of time and may still effectively use perfect gym towel 100 for absorbing sweat 160 from skin 145. In this way the present invention is multi-purpose in nature.

In continuing to refer to FIG. 3, fabric sheet 110 may be affixed to antibacterial barrier 120 via fabric fastener 320. In the embodiment shown in FIG. 3, fabric fastener 320 may comprise stitches 330, wherein stitches comprise a threading which may securely affix antibacterial barrier 120 to fabric sheet 110. It should be appreciated that in addition to providing a secure fabric fastener 320, stitches may comprise different colors and provide an increased aesthetic appearance to perfect gym towel 100. In alternative embodiments, fabric fastener 320 may comprise Velcro 332 or adhesive sheet 334. Adhesive sheet 334 may comprise a high-grade bonding solution or other comparable glue adaptable for use with both fabric sheet 110 and antibacterial barrier 120. It should be appreciated that other suitable equivalent bonding means may be used or that the present invention may be manufactured in alternate ways such as heat-shrinking/bonding the layers together or the like.

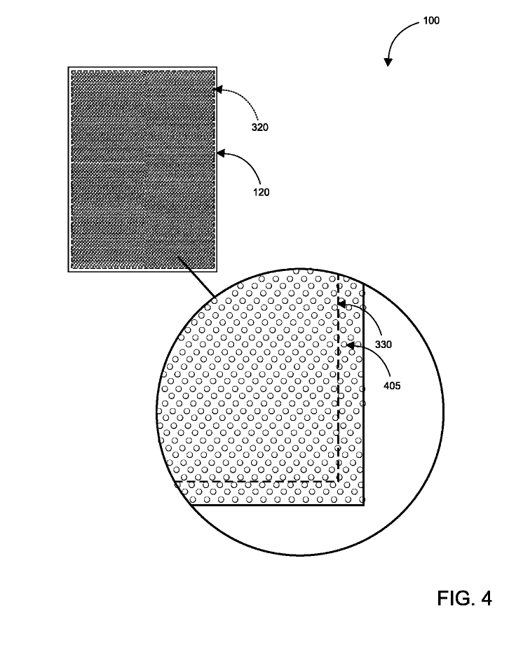

Now referring to FIG. 4, illustrating antibacterial barrier 120 according to a preferred embodiment of perfect gym towel 100. Antibacterial barrier 120 may be manufactured from an artificial elastomer. Further artificial elastomer may comprise a polymer suitable for resisting the absorption of liquids due to its inherent properties. Further, at ambient temperatures, elastomers are relatively soft and deformable making perfect gym towel 100 comfortable in use, yet durable. In alternative embodiments, antibacterial barrier 120 may comprise a natural elastomer which may serve the equivalent purpose as the artificial elastomer. In use, antibacterial barrier 120 provides an improved sanitary shielding surface so that gym-user 140 may place perfect gym towel 100 on a potentially contaminated surface during a resting condition 255. Antibacterial barrier may serve to minimize the risk of fabric sheet 110 from absorbing germs 182 and bacteria 184 left behind from other users.

In continuing to refer to FIG. 4, antibacterial barrier 120 may further comprise a plurality of small dimples 405 thereby creating a dimpled surface. Dimples 405 provide a slightly raised surface of antibacterial barrier 120. In use, gym-user 140 may place perfect gym towel 100 on an unsanitary surface, such as the floor of the gym or on exercise machine 130 and the elevated surface of dimples 405 may reduce the overall surface of contact. In such a manner, germs 182 and bacteria 184 are less likely to transfer to antibacterial barrier 120. Further, dimples 405 may provide greater traction (friction coefficient increasing means) when gym-user 140 places perfect gym towel 100 on a surface to be stored while in resting condition 255. For example, exercise machine 130 may have a beam or an arm which may be used to temporarily hang perfect gym towel 100. Dimples 405 may help retain perfect gym towel 100 thereby serving to minimize the chances of perfect gym towel from falling to the floor and landing on fabric sheet 110 comprising an absorbent surface.

In alternative embodiments of perfect gym towel 100, various types of indicia in the form of writing, a logo, or a symbol may be inscribed on either fabric sheet 110 and/or antibacterial barrier 120. The various forms of indicia may serve as a marketing and promoting tool for a gym, or for companies who may wish to sponsor the gym. Further, perfect gym towel 100 may comprise writing that depicts the name or signature of the owner. This may be useful in personalizing perfect gym towel 100 to the standards of gym-user 140 so that it may be easy to identify. For example, should perfect gym towel 100 become lost or misplaced in a public facility, the unique signature may assist gym-user 140 in locating perfect gym towel 100. Rubber-based material of perfect gym towel 100 may comprises a solid, bright color that is readily user-identifiable such that gym-user 140 is able to claim his/her perfect gym towel 100 thereby avoiding cross-contamination.

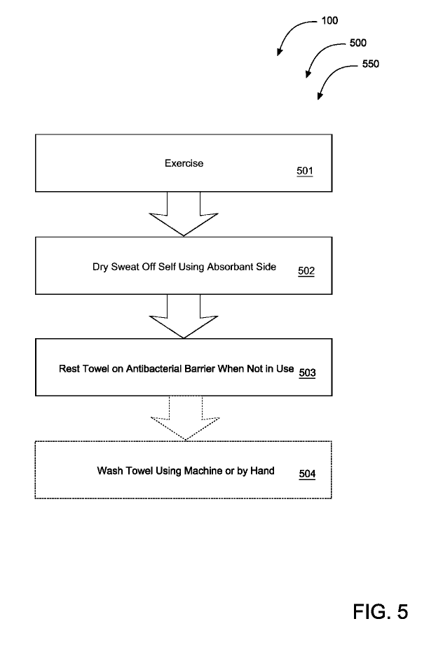

FIG. 5 shows flowchart 550 illustrating method of use 500 of perfect gym towel 100 according to a preferred embodiment of the present invention of FIGS. 1-4.

Method of use 500 may comprise the steps of: step one 501 engaging in exercise activity, step two 502 drying sweat 160 off skin 135 using fabric sheet 110 of perfect gym towel 100, step three 503 resting antibacterial barrier 120 of perfect gym towel 100 on exercise machine 130 or other contaminated surface, and step four 504 washing perfect gym towel 100 by hand or using a washing machine in between exercise activity.

It should be noted that step four 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A multi-purpose gym towel comprising:
at least one rectangular, fabric-based sheet cut to a pre-selected size comprising a wicking volume for absorbing sweat;
at least one rectangular, rubber-based material cut to said pre-selected size comprising a water/sweat-proof surface; and
a fabric fastener;
wherein said at least one rectangular fabric-based sheet is attached to said at least one rectangular rubber-based material via said fabric fastener thereby creating said multi-purpose gym towel;
wherein said multi-purpose gym towel is multi-layer; and
wherein said multi-purpose gym towel provides at least one sweat absorber and at least one sanitary barrier for use before and during exercise activities.

2. The multi-purpose gym towel of claim 1 wherein said rectangular, fabric-based sheet comprises terrycloth.

3. The multi-purpose gym towel of claim 2 wherein said terrycloth comprises sweat absorbing loops.

4. The multi-purpose gym towel of claim 3 wherein said sweat absorbing loops increase said wicking volume and surface area evaporation potential.

5. The multi-purpose gym towel of claim 1 wherein said at least one rectangular, fabric-based sheet provides a protective barrier between hands of a user and a surface of an exercise device.

6. The multi-purpose gym towel of claim 1 wherein said rectangular, rubber-based material provides said at least one sanitary barrier preventing contact by a user with germs and bacteria present on an exercise device.

7. The multi-purpose gym towel of claim 1 wherein said rectangular, rubber-based material comprises an artificial elastomer.

8. The multi-purpose gym towel of claim 7 wherein said artificial elastomer comprises a polymer.

9. The multi-purpose gym towel of claim 1 wherein said rectangular, rubber-based material comprises a natural elastomer.

11. The multi-purpose gym towel of claim 1 wherein said rectangular, rubber-based material comprises a solid, at least one bright color that is readily user-identifiable and such that said water/sweat-proof surface is distinguishable from said wicking volume.

12. The multi-purpose gym towel of claim 1 wherein said fabric fastener comprises stitches.

13. The multi-purpose gym towel of claim 1 wherein said fabric fastener comprises Velcro.

14. The multi-purpose gym towel of claim 1 wherein said fabric fastener comprises an adhesive.

15. The multi-purpose gym towel of claim 14 wherein said adhesive comprises glue.

16. The multi-purpose gym towel of claim 1 wherein said rectangular, fabric-based sheet comprises microfiber.

17. The multi-purpose gym towel of claim 1 wherein said rectangular, fabric-based sheet and said rectangular, rubber-based material comprises material that is machine-washable.

18. A multi-purpose gym towel for use by a gym-user during a workout comprising:
at least one rectangular, fabric-based sheet manufactured from terrycloth comprising sweat absorbing loops, wherein said terrycloth is cut to a pre-selected size, wherein said sweat absorbing loops comprise a wicking volume for absorbing sweat; and wherein said sweat absorbing loops comprise a first bright color identifying that it is a side of said fabric-based sheet;
at least one rectangular, rubber-based material manufactured from artificial elastomer cut to said pre-selected size, wherein said artificial elastomer comprises a polymer comprising a water/sweat-proof surface for providing a sanitary barrier preventing contact by said gym-user with germs and bacteria present on an exercise device; and wherein said water/sweat-proof surface comprises a second bright color identifying that it is a side of said rubber-based material;
a fabric fastener;
wherein said rectangular fabric-based sheet is attached to said rectangular rubber-based material via said fabric fastener thereby creating said multi-purpose gym towel;
wherein said multi-purpose gym towel is multi-layer; and
wherein said multi-purpose gym towel provides a multi-purpose sanitary wipe for said gym-user before, during, and after said workout.

19. A method of using a multi-purpose gym towel comprising the steps of:
engaging in an exercise activity;
drying sweat off skin using a sweat-absorbent side of said multi-purpose gym towel; and
resting said multi-purpose gym towel on side comprising water/sweat-proof surface during periods of non-use.

20. The method of claim 19 further comprising the step of washing said multi-purpose gym towel in between engagements in said exercise activity.
